(19) United States
(12) Patent Application Publication
(10) Pub. No.: US 2015/0155664 A1
(43) Pub. Date: Jun. 4, 2015

(54) ELECTRICAL CONNECTOR ASSEMBLY

(71) Applicant: Cheng Uei Precision Industry Co., Ltd., New Taipei City (TW)

(72) Inventors: XUE WEN LU, Dong-Guan City (CN); FENG MING YANG, New Taipei City (TW)

(73) Assignee: Cheng Uei Precision Industry Co., Ltd., New Taipei City (TW)

(21) Appl. No.: 14/093,394

(22) Filed: Nov. 29, 2013

(51) Int. Cl. H01R 24/70; H01R 24/78

(52) U.S. Cl. CPC H01R 24/70; H01R 24/78

(57) ABSTRACT

An electrical connector assembly includes a first connector, a second connector and a shielding shell. The first connector includes a first insulating housing and a plurality of first terminals. The second connector includes a second insulating housing and a plurality of second terminals. The shielding shell includes a first interface and a second interface. The first terminals are fixed in the first insulating housing. The second terminals are fixed in the second insulating housing. The first insulating housing with the first terminals are received in the first interface of the shielding shell and the second insulating housing with the second terminals are received in the second interface. The second insulating housing is embedded in the first insulating housing and the tails of the second terminals are overlapped the tails of the first terminals respectively. The shielding shell encloses the first connector and the second connector.

### BACKGROUND OF THE INVENTION

1. Field of the Invention

The present invention relates to an electrical connector, and more particularly to an electrical connector assembly.

2. The Related Art

Nowadays, with the progress of society, cars have become a common traffic tools in stead of walking and bicycling. The cars decorate with the audio and visual device such as VCD (Video Compact Disc) device in order to improve the comfort level in a long journey. The audio and visual device electrically connects to the circuit of the car by an electrical connector assembly. A traditional electrical connector assembly includes a first connector connecting to the circuit of the car, a second connector connecting to the audio and visual device and a PCB (Printed Circuit Board). The first and second connector soldered on the PCB by SMT (Surface Mount Technology) and electrical connect by the trace of the PCB.

However, the traditional electrical connector assembly pastes the first and second connectors on PCB by virtue of SMT process, it makes the operation not only complex, but also wastes a lot of manpower and material resources.

### SUMMARY OF THE INVENTION

Accordingly, an object of the present invention is to provide an electrical connector assembly. The electrical connector assembly includes a first connector, a second connector and a shielding shell. The first connector includes a first insulating housing and a plurality of first terminals. The second connector includes a second insulating housing and a plurality of second terminals. The shielding shell includes a first interface and a second interface. The first terminals are fixed in the first insulating housing. The second terminals are fixed in the second insulating housing. The first insulating housing with the first terminals are received in the first interface of the shielding shell and the second insulating housing with the second terminals are received in the second interface. The second insulating housing is embedded in the first insulating housing and the tails of the second terminals are overlapped the tails of the first terminals respectively. The shielding shell encloses the first connector and the second connector.

As described above, the embodiment of the invention of the electrical connector assembly with the tails of the first overlap portions of the first terminals overlap joint and electrically connect to the tails of the second terminals, and the second insulating housing is embedded in the first insulating housing. It doesn't need to solder by SMT process, but also can be assembled quickly and accurately, thus it saves a lot of manpower and material resources, reduces the production cost and further improves the production efficiency.

### BRIEF DESCRIPTION OF THE DRAWINGS

The present invention will be apparent to those skilled in the art by reading the following description thereof, with reference to the attached drawings, in which:

FIG. 1 is an assembled, perspective view of an electrical connector assembly with shielding shell separated from the insulating housing in accordance with an embodiment of the present invention;

FIG. 2 is an exploded, perspective view of an electrical connector assembly in accordance with an embodiment of the present invention;

FIG. 3 is an assembled, perspective view of the second insulating housing of the electrical connector assembly shown in FIG. 1; and

FIG. 4 is a cross-sectional view of the electrical connector assembly taken along line IV-IV shown in FIG. 1.

### DETAILED DESCRIPTION OF THE EMBODIMENT

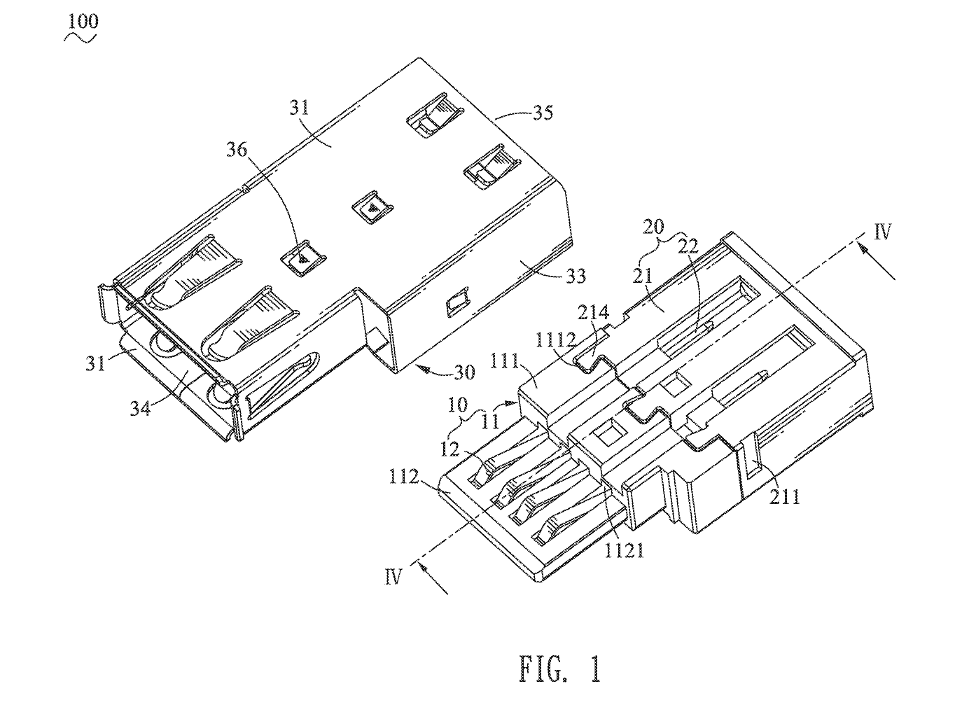

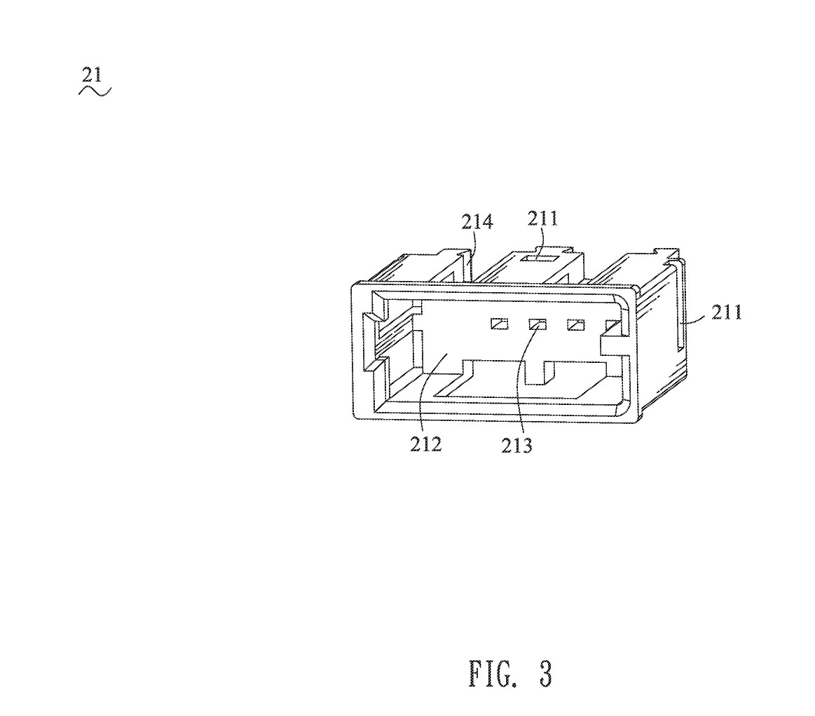

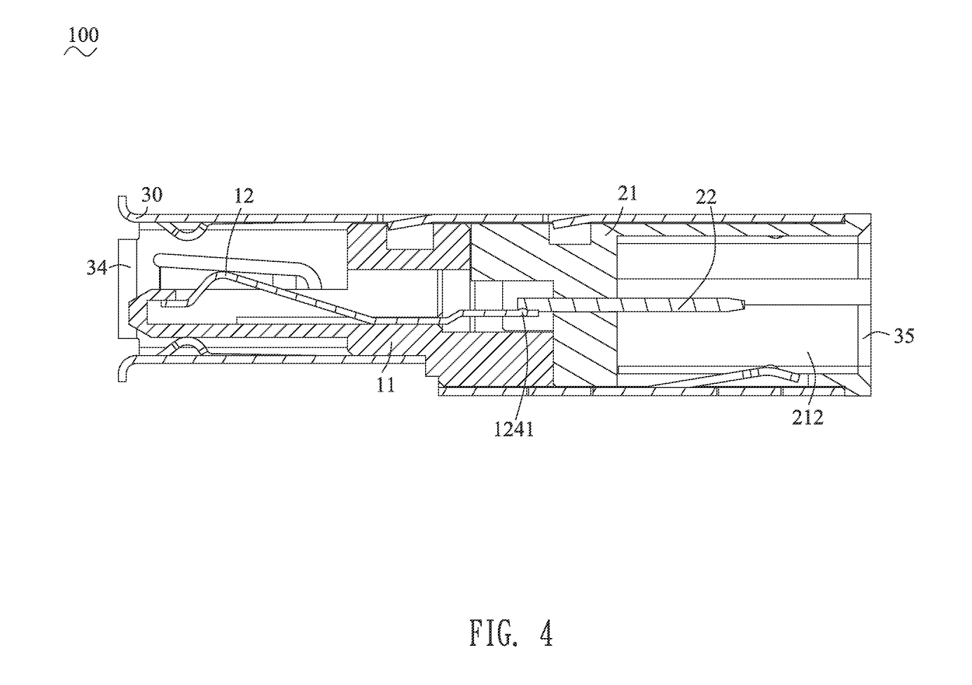

Referring to the drawings, FIGS. 1-4, in much detail, and first to FIG. 1, an embodiment of the present invention is shown as an electrical connector assembly 100. The electrical connector 100 includes a first connector 10, a second connector 20 electrically connects to the first connector 10, and a shielding shell 30 encloses the first connector 10 and the second connector 20.

The first connector 10 includes a first insulating housing 11 and a plurality of first terminals 12. The first insulating housing 11 has a base portion 111. A front of the base portion 111 extends frontward to form a tongue board 112 having a smaller dimension than the base portion 111. The tongue board 112 defines a plurality of first terminal grooves 1121 penetrating rearward through the base portion 111 of the first insulating housing 11. A substantial middle of a top face of the base portion 111 is concaved downward to form a first trough 1111. A rear end of the base portion 111 is concaved frontward to form a plurality of swallow-tailed fillisters 1112 penetrating upward through the top face of the base portion 111. The dimension of the opening of the swallow-tailed fillisters 1112 is smaller than the bottom of the swallow-tailed fillisters 1112. Two opposite sides of the outer sidewalls of the swallow-tailed fillisters 1112 are concaved outward to form a plurality of locking troughs 1113.

The first terminals 12 each has a first fastening strip 121, a first elastic portion 122 and a first overlap portion 124 which are connected with two opposite ends of the first fastening strip 121. The first elastic portion 122 is meandered frontward from a front end of the first fastening strip 121 to substantially show an inverted-V shape and a front end of the first elastic portion 122 of the first terminal 12 extends forward to form a first blocking portion 123. The first overlap portion 124 is formed by a rear end of the first fastening strip 121 extending rearward. A rear end of a top face of each first overlap portion 124 protrudes upward to form a convex 1241. The embodiment of the first connector 10 is USB (Universal Serial Bus) connector.

The second connector 20 includes a second insulating housing 21 and a plurality of second terminals 22. The second insulating housing 21 is an integral structure. A top and two side faces of the second insulating housing 21 are concaved inward to form a plurality of second troughs 211. A rear of the second insulating housing 21 is concaved frontward to form a butting trough 212. The second insulating housing 21 defines a plurality of second terminal grooves 213 penetrating frontward through the second insulating housing 21 and connecting rearward to the butting trough 212. A front end of the second insulating housing 21 penetrates frontward to form a plurality of swallow-tailed lumps 214. The dimension of the tail of the swallow-tailed lumps 214 are larger than the parts of the swallow-tailed lumps connecting to the second insulating housing 21. Two opposite sides of the outer of the swallow-tailed lumps 214 protrude outward to form a plurality of fastening lumps 215 corresponding to the locking troughs 1113 of the first insulating housing 111.

The second terminals 22 each has a second fastening strip 221, a second overlap portion 222 and a second inserting portion 223 which are connected with two opposite ends of the second fastening strip 221. The second overlap portion 222 and the second inserting portion 223 are formed by a front end and a rear end of the second fastening strip 221 extending rearward and frontward. The embodiment of the second connector 20 is a 4-PIN automotive connector.

The shielding shell 30 has a top plate 31, a bottom plate 32 and two side plates 33 which corporately define a receiving chamber (not labeled). The receiving chamber includes a first interface 34 and a second interface 35. The top plate 31, bottom plate 32 and two side plates 33 are punched inward to form a plurality of elastic slices 36.

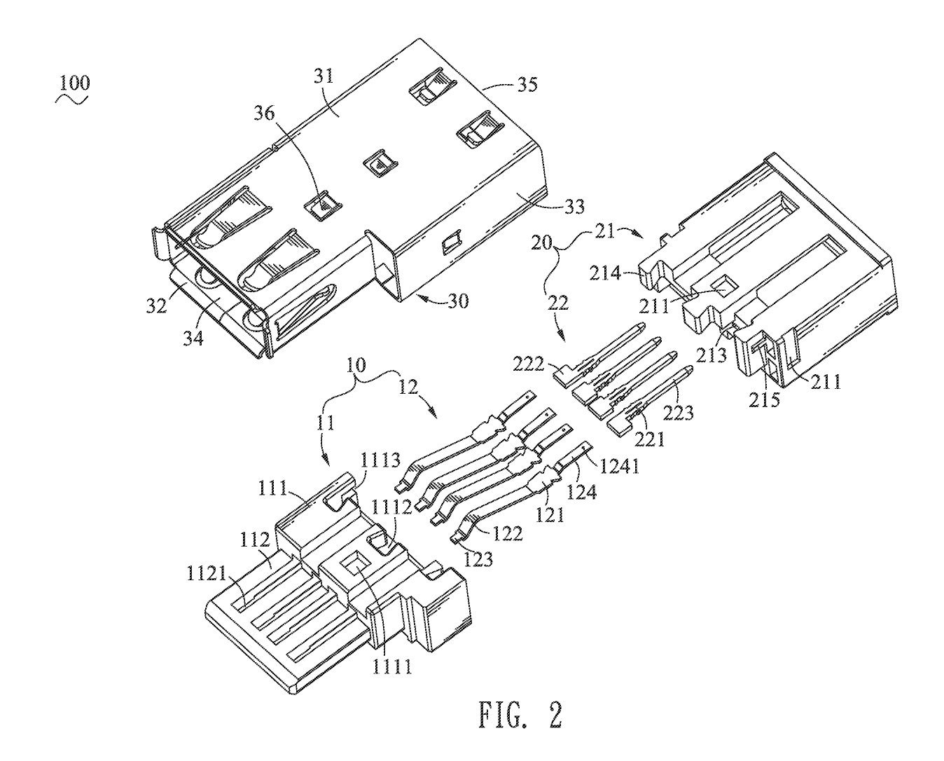

Refer to FIG. 2, in assembly, the first terminals 12 are inserted frontward into the first terminal grooves 1121 and are fixed in the first insulating housing 11. The first fastening strips 121 of the first terminals 12 are fastened in the first terminal grooves 1121 of the first insulating housing 11. The first elastic portions 122 of the first terminals 12 are elastically received in the first terminal grooves 1121 and projecting beyond the top face of the tongue board 112. The first blocking portions 123 of the first terminals 12 are held in the first terminal grooves 1121. The first overlap portions 124 are received in the first terminal grooves 1121 of the base portion 111 of the first insulating housing 11. The second terminals 22 are inserted rearward into the second terminal grooves 213 and are fixed in the second insulating housing 21. The second fastening strips 221 of the second terminals 22 are fastened in the second terminal grooves 213 of the second insulating housing 21. The second overlap portions 222 are projecting beyond the front face of the second insulating housing 21 and the second inserting portions 223 are received in the butting trough 212 of the second insulating housing 21.

The second insulating housing 21 with the second terminals 22 are inserted downward into the first insulating housing 11. The first insulating housing 11 with the first terminals 12 are received in the first interface 34 of the shielding shell 30 and the second insulating housing 21 with the second terminals 22 are received in the second interface 35 of the shielding shell 30. The second insulating housing 21 is embedded in the first insulating housing 11. In detail, the swallow-tailed lumps 214 of the second insulating housing 21 are buckled in the swallow-tailed fillisters 1112 of the first insulating housing 11. The fastening lumps 215 of the second insulating housing 21 are embedded in the locking troughs 1113 of the first insulating housing 11. The tails of the second overlap portions 222 of the second terminals 22 are overlapped butt the tails of the first overlap portions 124 of the first terminals 12 respectively and the convex 1241 are electrically connect to the bottom face of the second overlap portions 222 of the second terminals 22.

The shielding shell 30 encloses rearward the first insulating housing 11 and the second insulating housing 21. The first insulating housing 11 with the first terminals 12 are held in the first interface 34 of the shielding shell 30 and the second insulating housing 21 with the second terminals 22 are held in the second interface 35 of the shielding shell 30. The elastic slices 36 of the shielding shell 30 are buckled in the first troughs 1111 of the first insulating housing 11 and the second troughs 211 of the second insulating housing 21 respectively.

As described above, the embodiment of the invention of the electrical connector assembly 100 with the convex 1241 of the first overlap portions 124 of the first terminals 12 overlap joint and electrically connect to the second overlap portions 222 of the second terminals 22, and the swallow-tailed lumps 214 of the second insulating housing 21 are buckled in the swallow-tailed fillisters 1112 of the first insulating housing 11. It doesn't need to solder by SMT process, but also can be assembled quickly and accurately, thus it saves a lot of manpower and material resources, reduces the production cost and further improves the production efficiency.

What is claimed is:

1. An electrical connector assembly, comprising:
a first connector including a first insulating housing and a plurality of first terminals;
a second connector including a second insulating housing and a plurality of second terminals; and
a shielding shell enclosing the first connector and the second connector, including a first interface and a second interface;
wherein the first terminals are fixed in the first insulating housing, the second terminals are fixed in the second insulating housing, the first insulating housing with the first terminals are received in the first interface of the shielding shell and the second insulating housing with the second terminals are received in the second interface of the shielding shell, the second insulating housing is embedded in the first insulating housing and the tails of the second terminals are overlapped butt the tails of the first terminals respectively.

2. The electrical connector assembly as claimed in claim 1, wherein the first insulating housing including a base portion, a front of the base portion extending frontward to form a tongue board having a smaller dimension than the base portion, the tongue board defining a plurality of first terminal grooves penetrating rearward through the base portion of the first insulating housing, wherein the second insulating housing defining a plurality of second terminal grooves penetrating frontward through the second insulating housing, the first terminals are inserted frontward into the first terminal grooves and the second terminals are inserted rearward into the second terminal grooves.

3. The electrical connector assembly as claimed in claim 2, wherein the first terminals each having a first fastening strip, a first elastic portion and a first overlap portion which are connected with two opposite ends of the first fastening strip, a first overlap portion being formed by a rear end of the first fastening strip extending rearward, wherein the second terminals each having a second fastening strip, a second overlap portion and a second inserting portion which are connected with two opposite ends of the second fastening strip, the first fastening strips of the first terminals are fastened in the first terminal grooves of the first insulating housing, the first elastic portions of the first terminals are elastically received in the first terminal grooves and projecting beyond the top face of the tongue board, the first blocking portions of the first terminals are held in the first terminal grooves, the first overlap portions are received in the first terminal grooves of the base portion of the first insulating housing, the second fastening strips of the second terminals are fastened in the second terminal grooves of the second insulating housing, the second overlap portions are projecting beyond the front face of the second insulating housing and the second inserting portions are received in the second insulating housing.

4. The electrical connector assembly as claimed in claim 3, wherein a rear end of a top face of each first overlap portion protruding upward to form a convex, the second overlap portions of the second terminals are overlap butt the first overlap portions of the first terminals respectively and the convex are electrically connect to the bottom face of the second overlap portions of the second terminals.

5. The electrical connector assembly as claimed in claim 4, wherein the first connector is USB connector, the second connector is a 4-PIN automotive connector.

6. The electrical connector assembly as claimed in claim 1, wherein a rear end of the first insulating housing being concaved frontward to form a plurality of swallow-tailed fillisters penetrating upward through the top face of the first insulating housing, a front end of the second insulating housing penetrating frontward to form a plurality of swallow-tailed lumps, the swallow-tailed lumps of the second insulating housing are buckled in the swallow-tailed fillisters of the first insulating housing.

7. The electrical connector assembly as claimed in claim 6, wherein the dimension of the opening of the swallow-tailed fillisters is smaller than the bottom of the swallow-tailed fillisters, the dimension of the tail of the swallow-tailed lumps is larger than the parts of the swallow-tailed lumps connecting to the second insulating housing.

8. The electrical connector assembly as claimed in claim 6, wherein two opposite sides of the outer sidewalls of the swallow-tailed fillisters being concaved outward to form a plurality of locking troughs, two opposite sides of the outer of the swallow-tailed lumps protruding outward to form a plurality of fastening lumps corresponding to the locking troughs of the first insulating housing, the fastening lumps of the second insulating housing are embedded in the locking troughs of the first insulating housing.

9. The electrical connector assembly as claimed in claim 1, wherein a top face of the first insulating housing being concaved downward to form a first trough, a top and two side faces of the second insulating housing being concaved inward to form a plurality of second troughs, wherein the shielding shell further having a top plate, a bottom plate and two side plates, the top plate, bottom plate and two side plates being punched inward to form a plurality of elastic slices, the elastic slices of the shielding shell are buckled in the first troughs of the first insulating housing and the second troughs of the second insulating housing respectively.
